(19) United States
(12) Patent Application Publication
(10) Pub. No.: US 2006/0275108 A1
(43) Pub. Date: Dec. 7, 2006

(54) Hammerhead fluid seal

(76) Inventors: Robert L. Memmen, Cheshire, CT (US); Gary Bash, Jupiter, FL (US)

Correspondence Address: PRATT & WHITNEY, 400 MAIN STREET, MAIL STOP: 132-13, EAST HARTFORD, CT, 06108, US

(21) Appl. No.: 11/146,801

(22) Filed: Jun. 7, 2005

(51) Int. Cl. F03B 11/00

(52) U.S. Cl. 415/110

(57) ABSTRACT

Disclosed are assemblies and articles for restricting leakage of a pressurized fluid from a cavity flanked by a vane support and a bladed rotor assembly. In accordance with an embodiment of the invention, the vane support defines a circumferential channel, and a interrupted rim region of the bladed rotor assembly defines a segmented ring. The segmented ring protrudes outward from the bladed rotor assembly, spans across the cavity and into the channel to define a seal.

### CROSS-REFERENCE TO RELATED APPLICATIONS

This application discloses subject matter related to copending U.S. patent applications “COMBINED BLADE ATTACHMENT AND DISK LUG FLUID SEAL” (APPLICANT REFERENCE NUMBER EH-11598) and “BLADE NECK FLUID SEAL” (APPLICANT REFERENCE NUMBER EH-11507) filed concurrently herewith.

### STATEMENT REGARDING FEDERALLY SPONSORED RESEARCH OR DEVELOPMENT

This invention was made with Government support under F33615-98-C-2801 awarded by the United States Air Force. The Government has certain rights in this invention.

### BACKGROUND OF THE INVENTION

(1) Field of the Invention

The invention relates to gas turbine engines, and more specifically to a seal for providing a fluid leakage restriction between components within such engines.

(2) Description of the Related Art

Gas turbine engines operate by burning a combustible fuel-air mixture in a combustor and converting the energy of combustion into a propulsive force. Combustion gases are directed axially rearward from the combustor through an annular duct, interacting with a plurality of turbine blade stages disposed within the duct. The blades transfer the combustion gas energy to one or more blades mounted on disks, rotationally disposed about a central, longitudinal axis of the engine. In a typical turbine section, there are multiple, alternating stages of stationary vanes and rotating blades disposed in the annular duct.

Since the combustion gas temperature may reach 2000 degrees Fahrenheit or more, some blade and vane stages are cooled with lower temperature cooling air for improved durability. Air for cooling the first-stage blades bypasses the combustor and is directed to an inner diameter cavity located between a first-stage vane support and a first-stage rotor assembly. The rotational force of the rotor assembly pumps the cooling air radially outward and into a series of conduits within each blade, thus providing the required cooling.

Since the outboard radius of the inner cavity is adjacent to the annular duct carrying the combustion gasses, it must be sealed to prevent leakage of the pressurized cooling air into the combustion gas stream. This area of the inner cavity is particularly challenging to seal, due to the differences in thermal and centrifugal growth between the stationary, first-stage vane support and the rotating, first stage rotor assembly. In the past, designers have attempted to seal the outboard radius of inner cavities with varying degrees of success.

An example of such an outboard radius seal is a labyrinth seal. In a typical configuration, a multi-step labyrinth seal separates the inner cavity into two regions of approximately equal size, an inner region and an outer region. Cooling air in the inner region is pumped between the rotating disk and labyrinth seal into the hollow conduits of the blades while the outer region is fluidly coupled to the annular duct carrying the combustion gases. A labyrinth seal's lands must be pre-grooved to prevent interference between the knife-edge teeth and the lands during a maximum radial excursion of the rotor. By designing the labyrinth seal for the maximum radial excursion of the rotor assembly, the leakage restriction capability is reduced during low to intermediate radial excursions of the rotor assembly. Any cooling air that leaks by the labyrinth seal is pumped through the outer region and into the annular duct by the rotating disk. This pumping action increases the temperature of the disk in the area of the blades and creates parasitic drag, which reduces overall turbine efficiency. The rotating knife-edges also add additional rotational mass to the gas turbine engine, which further reduces engine efficiency.

Another example of such an outboard radius seal is a brush seal. In a typical configuration, a brush seal separates the inner cavity into two regions, an inner region and a smaller, outer region. A freestanding sideplate assembly defines a disk cavity, which is in fluid communication with the inner region. Cooling air in the inner region enters the disk cavity and is pumped between the rotating sideplate and disk to the hollow conduits of the blades. The seal's bristle to land contact pressure increases during the maximum radial excursions of the rotor and may cause the bristles to deflect and ‘set’ over time, reducing the leakage restriction capability during low to intermediate rotor excursions. Any cooling air that leaks by the brush seal is pumped into the outer region by the rotating disk. This pumping action increases the temperature of the disk in the area of the blades and creates parasitic drag, which reduces overall turbine efficiency. The freestanding sideplate and minidisk also adds rotational mass to the gas turbine engine, which further reduces engine efficiency.

Although each of the above mentioned seal configurations restrict leakage of cooling air under certain engine operating conditions, a consistent leakage restriction is not maintained throughout all the radial excursions of the rotor. The seals may also increase the temperature of the disk and cooling air due to centrifugal pumping, reduce engine efficiency due to parasitic drag and add additional engine weight. What is needed is a seal that maintains a more consistent leakage restriction throughout all the radial excursions of the rotor, without negatively affecting disk and cooling air temperature, engine efficiency or engine weight.

### BRIEF SUMMARY OF THE INVENTION

In accordance with an embodiment of the present invention, there is provided a seal for restricting leakage of pressurized cooling air from an inner cavity flanked by a vane support and a bladed rotor assembly. The seal comprises a segmented ring defined by the bladed rotor assembly and a channel defined by the vane support. The bladed rotor assembly includes a disk rotationally disposed about a central axis of the engine. The disk includes a radially outermost rim and a plurality of slots circumferentially spaced about the rim for accepting an equal plurality of blades. An interrupted rim region extends radially outward from a radius circumscribing a radially innermost floor of each slot to the outermost rim. The segmented ring extends axially outward from the interrupted rim region towards the inner cavity. The circumferential channel defined by the vane support is open to the inner cavity and is located radially proximate the axially extending ring. The ring spans across the cavity and into the channel to define a seal with a more consistent leakage restriction throughout the entire range of engine operating conditions. Since a cooling air leakage restriction occurs at both inner and outer radial locations, the radial growth of the rotor assembly in relation to the vane support is accounted for.

Also, by locating the seal radially outboard and in the interrupted rim region of the disk, temperature rise and parasitic drag due to pumping are minimized. Engine rotating mass is reduced with the elimination of freestanding sideplates and complex, multi-step labyrinth seal hardware as well.

Other features and advantages will be apparent from the following more detailed descriptions, taken in conjunction with the accompanying drawings, which illustrate by way of an example a seal in accordance with a preferred embodiment of the invention.

### BRIEF DESCRIPTION OF THE SEVERAL VIEWS OF THE DRAWINGS

FIG. 1 is a simplified schematic sectional view of a gas turbine engine along a central, longitudinal axis.

FIG. 2 is a partial sectional view of a turbine rotor assembly of the type used in the engine of FIG. 1, showing a seal in accordance with an embodiment of the present invention.

FIG. 2a is a detailed view of a seal in accordance with an embodiment of the present invention.

FIG. 3 is a partial isometric view of the rotor assembly of FIG. 2 showing a seal in accordance with an embodiment of the present invention.

FIG. 4 is a partial front view of the rotor assembly of FIG. 2 showing a seal in accordance with an embodiment of the present invention.

FIG. 5 is a simplified sectional view of a seal in accordance with an embodiment of the present invention as assembled.

FIG. 6 is a simplified sectional view of a seal in accordance with an embodiment of the present invention during an engine take-off condition.

FIG. 7 is a simplified sectional view of a seal in accordance with an embodiment of the present invention during an engine cruise condition.

### DETAILED DESCRIPTION OF THE INVENTION

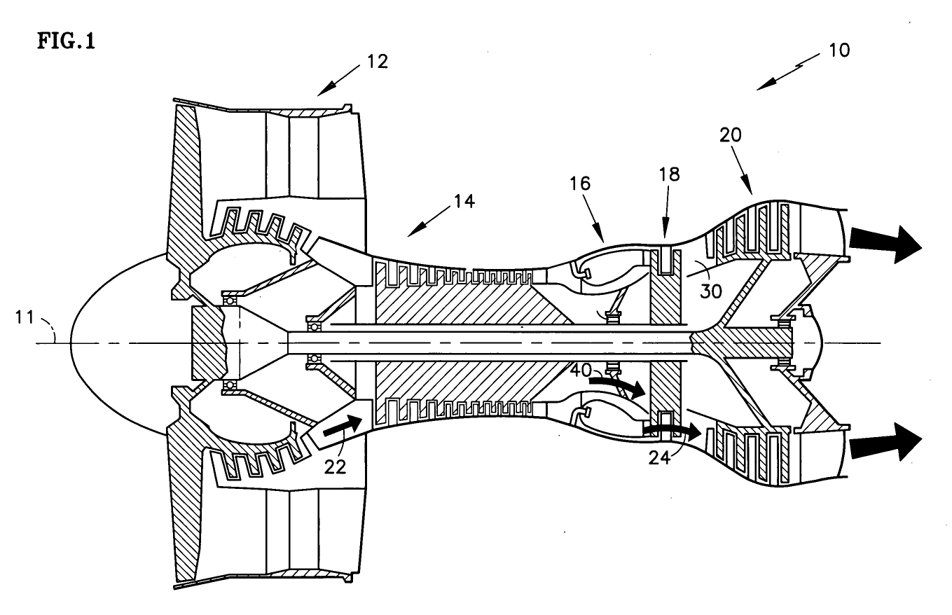

The major sections of a typical gas turbine engine 10 of FIG. 1 include in series, from front to rear and disposed about a central longitudinal axis 11, a low-pressure compressor 12, a high-pressure compressor 14, a combustor 16, a high-pressure turbine 18 and a low-pressure turbine 20. A working fluid 22 is directed rearward through the compressors 12, 14 and into the combustor 16, where fuel is injected and the mixture is burned. Hot combustion gases 24 exit the combustor 16 and expand within an annular duct 30 through the turbines 18, 20 and exit the engine 10 as a propulsive thrust. A portion of the working fluid 22 exiting the high-pressure compressor 14, bypasses the combustor 16 and is directed to the high-pressure turbine 18 for use as cooling air 40.

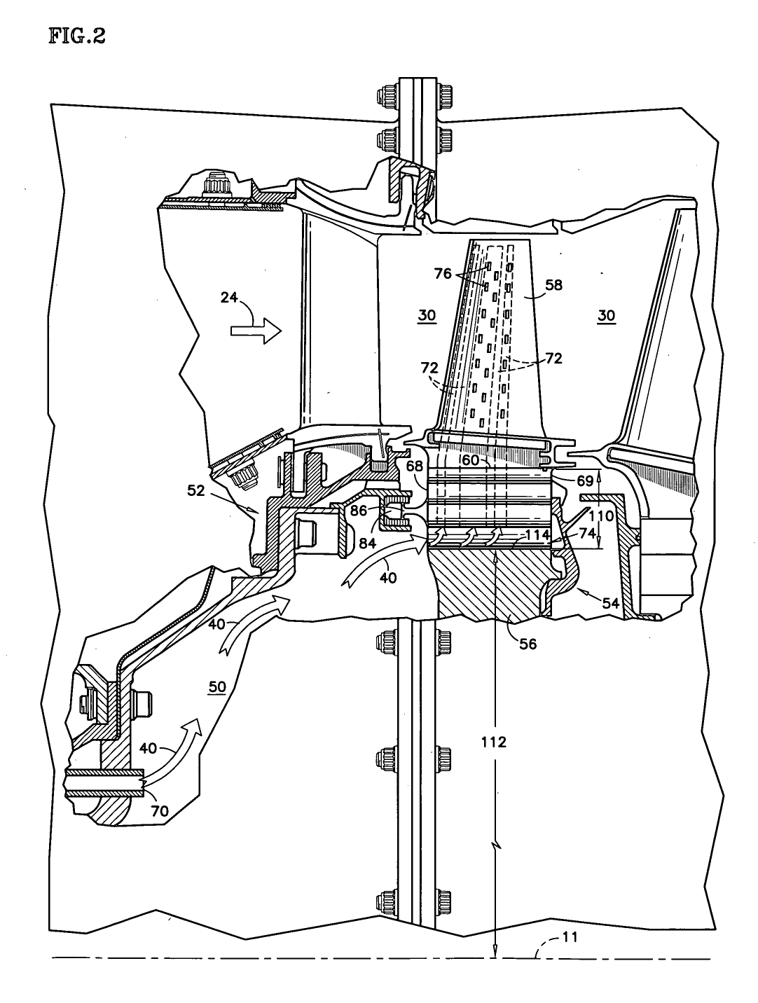

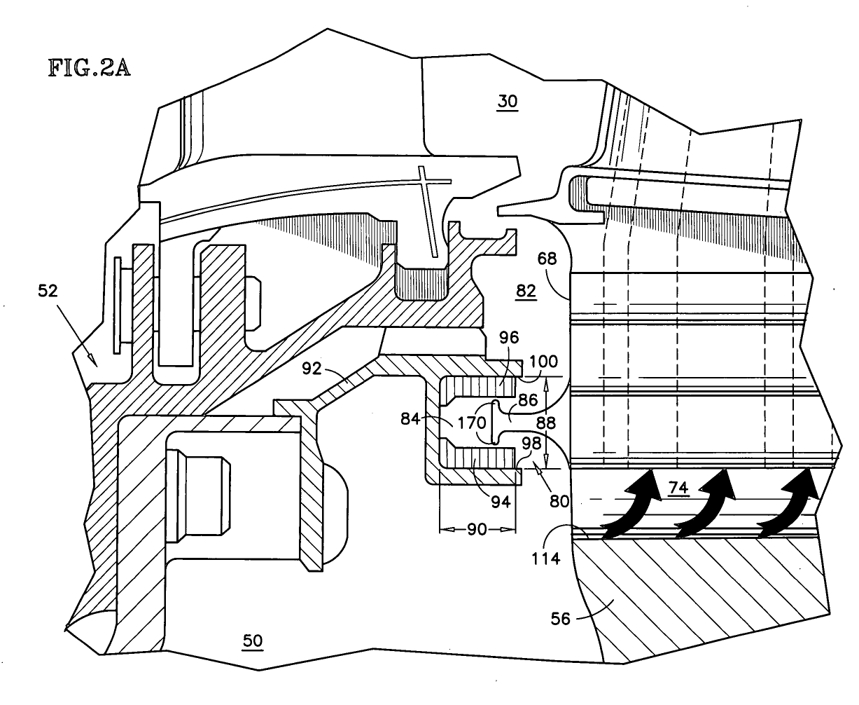

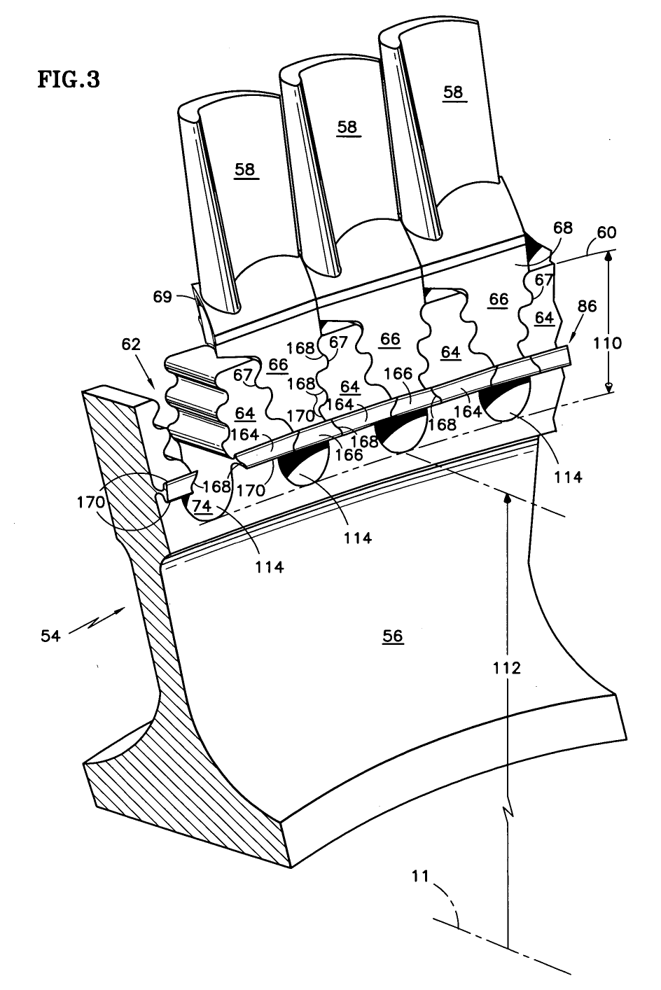

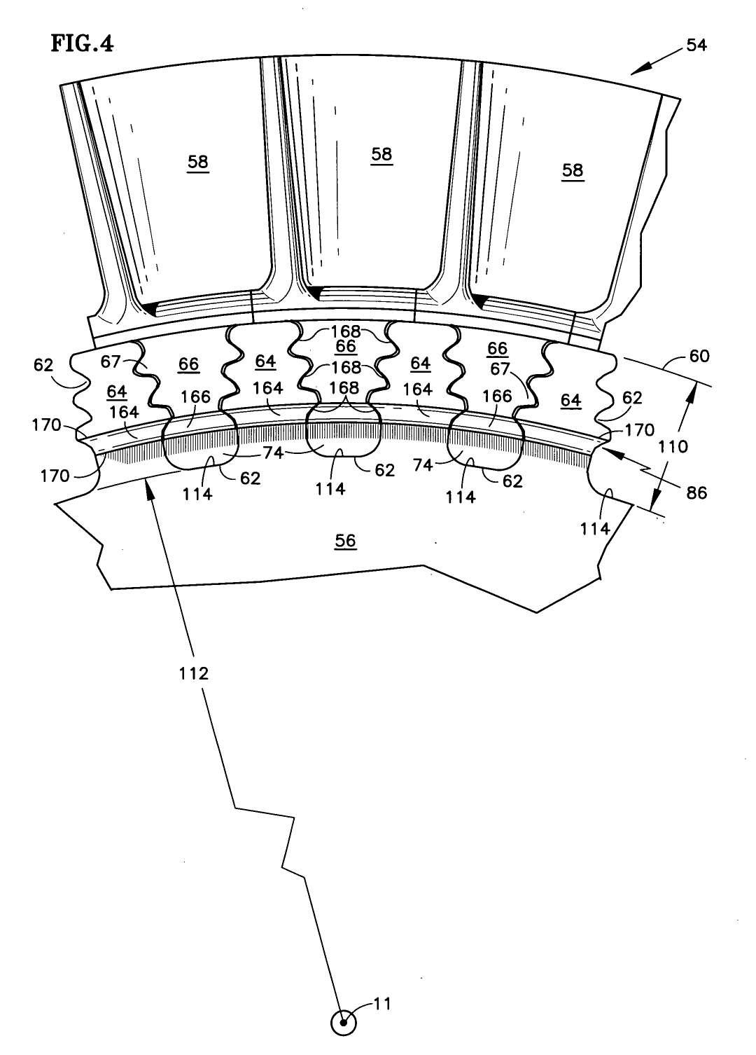

Referring now to the example of FIGS. 2 and 2a, an inner cavity 50 is located radially inward of the annular duct 30 and axially between a first-stage vane support 52 and a first-stage rotor assembly 54. The rotor assembly comprises a disk 56 and a plurality of outwardly extending blades 58, rotationally disposed about the central axis 11. As best shown in FIGS. 3 and 4, the disk 56 includes a radially outermost rim 60, a plurality of fir tree profiled slots 62 and a plurality of lugs 64 alternating with the slots 62 about the circumference of the rim 60. Each slot 62 accepts a radially lower most attachment 66 of a blade 58 in a sliding arrangement. One or more teeth 67 extend between a forward, axial face 68 and a rearward, axial face 69 of the attachment 66, engaging adjacent lugs 64 to prevent loss of the blade 58 as the disk 56 rotates. The one or more teeth 67, project a complementary fir tree profile about the periphery of each face 68, 69.

During the engine 10 operation, pressurized cooling air 40 is pumped into the inner cavity 50 by a duct 70, where a major portion of the cooling air 40 is dedicated to internally cooling the blades 58. The cooling air 40 enters the blades 58 via a series of radially extending conduits 72 communicating with a plenum 74 radially flanked by the blade attachment 66 and the disk 56. The cooling air 40 exits the blade 58 via a series of film holes 76. To ensure a continuous flow of cooling air 40 through the blade 58, the pressure of the cooling air 40 must remain greater than the pressure of the combustion gases 24 or the combustion gases 24 may backflow into the film holes 76, potentially affecting the durability of the blade 58.

An exemplary seal 80 in accordance with an embodiment of the invention separates the inner cavity 50 from the annular duct 30, thus ensuring adequate cooling air 40 pressure throughout all engine-operating conditions. The seal 80 is located radially inward of the annular duct 30, defining an outer cavity 82 therebetween. Since the outer cavity 82 is relatively small, any leakage of cooling air 40 through the seal 80 is subject to relatively minimal pumping by the rotor assembly 54, prior to mixing with the combustion gases 24. This level of pumping has limited negative impact on disk 56 temperature and aerodynamic drag, thus improving engine efficiency.

The exemplary seal 80 comprises a channel 84 in the vane support 52 and a segmented ring 86 defined by the rotor assembly 54. The channel 84 is circumferentially disposed and has a radial height 88, an axial depth 90 and is open to the inner cavity 50. In the example shown in FIGS. 2 and 2a, the channel 84 has a ‘C’ shaped cross sectional profile; however, other cross sectional profiles may be used. The channel 84 may be integrally defined by the vane support 52 or may be defined by a separate arm 92 and affixed to the vane support 52 by welding, bolting, riveting or other suitable means. A radially inner land 94 and a radially outer land 96 are affixed to an inner radial face 98 and an outer radial face 100 of the channel 84 respectively. The lands 94, 96 are comprised of a honeycomb, abradable rubber or other structure known in the sealing art.

The segmented ring 86 is radially located in an interrupted rim region 110 of the disk 56. The interrupted rim region 110 extends radially outward from a radius 112 circumscribing a floor 114 of each slot 62 to the outer rim 60. As best shown in FIG. 3, a first number 164 of the ring segments are defined by the disk lugs 64 and a second number 166 of the ring segments are defined by the blade attachments 66. The first number of segments 164 are preferably formed with the disk 56 prior to milling or broaching of the slots 62. The second number of segments 166 are preferably cast or forged integrally with the blades 58 and machined with the attachment 66. With the blades 58 interposed with the lugs 64, the first 164 and second 166 ring segments substantially align, defining a complete segmented ring 86.

Referring now to FIG. 4, tangential sealing between adjacent ring segments 164, 166 occurs as centrifugal forces draw the blade 58 radially outward against the lugs 64 during engine operation. To achieve this sealing, the segmented ring 86 is radially positioned to include a contact surface 168 located at the interface of the lug 64 and the attachments 66. Although an innermost contact surface 168 is included in the example for reduced weight, any one or more of the contact surfaces 168 may be included.

A circumferential runner 170 extends radially outward from the segmented ring 86 and a circumferential runner 170 extends radially inward from the segmented ring 86. It is preferable for the axial width of the runners 170 to be as thin as possible adjacent to the lands 94, 96 to reduce the velocity of any cooling air 40 flowing there between. Although the runners 170 are shown in the figures at the forward extent of the segmented ring 86, multiple runners 170 may be positioned anywhere along the axial length of the segmented ring 86. Since intermittent contact between a runner 170 and a land 94, or 96 may occur, a coating, hard face or other wear-resistant treatment is typically applied to the runner 170.

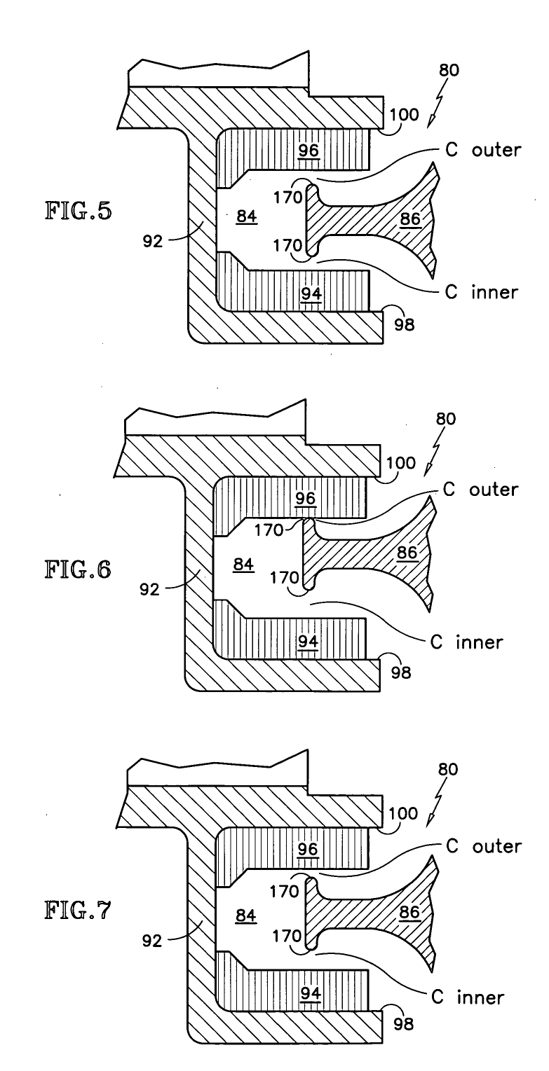

With the rotor assembly 54 installed in the high pressure turbine 18, the segmented ring 86 extends outward from the interrupted rim region 110, spans across the inner cavity 50 and into the channel 84, aligning the runners 170 axially with the lands 94, 96. The radial height 88 of the channel 84 is slightly oversized to provide sufficient clearance between the lands 94, 96 and the runners 170, preventing interference while being assembled and during operation of the engine 10. As shown in FIG. 5, an inner clearance C_{INNER} of about (0.020) inch and an outer clearance C_{OUTER} of about (0.020) inch ensure that the runners 170 do not interfere with the lands 94, 96 during assembly.

By utilizing at least two radially opposed runners 170, a more consistent leakage restriction is maintained in the seal 80 throughout all engine-operating conditions. During engine take-off conditions, as shown in FIG. 6, a maximum radial growth of the rotor assembly 54 occurs, closing the outer clearance C_{OUTER} to about (0.000) inch and opening the inner clearance C_{INNER} to about (0.040) inch. During engine cruise conditions, as shown in FIG. 7, the radial growth of the rotor assembly 54 stabilizes and the outer clearance C_{OUTER} is about (0.005) inch while the inner clearance C_{INNER} is about (0.035) inch.

Although an exemplary seal 80 has been shown positioned between a stationary member and a rotating member, it is to be understood that an exemplary seal 80 may also be located between two rotating members or two stationary members as well.

While the present invention has been described in the context of specific embodiments thereof, other alternatives, modifications and variations will become apparent to those skilled in the art having read the foregoing description. Accordingly, it is intended to embrace those alternatives, modifications and variations as fall within the broad scope of the appended claims.

What is claimed is:

1. In a gas turbine engine including a cavity for storing a pressurized fluid, a seal assembly for restricting leakage of the fluid from the cavity, comprising:
a rotor assembly, said rotor assembly including a disk rotationally disposed about a central axis of the engine, said disk including a radially outermost rim, a plurality of slots extending through an axial thickness of the disk and circumferentially spaced about the rim, a plurality of lugs interspersed with the slots and wherein each of the lugs includes a profile, an interrupted rim region extending radially outward from a radius circumscribing a radially innermost floor of the slots to the rim, and a plurality of blades interposed with the lugs, each of said blades including an attachment with a complementary profile for engaging adjacent lugs;
a support spaced axially from said rotor assembly such that said support and said rotor assembly flank the cavity, said support comprising a circumferential channel adjacent to the cavity and radially proximate the interrupted rim region; and
wherein said rotor assembly further comprises a segmented ring protruding outward from the interrupted rim region, said ring spanning axially across the cavity and into the channel to define the seal.

2. The seal of claim 1, wherein a first number of the ring segments are defined by the disk lugs and a second number of the ring segments are defined by the blade attachments such that when the blades are interposed with the lugs, the ring segments align, substantially defining the segmented ring.

3. The seal of claim 2, wherein the first number of ring segments alternate with the second number of ring segments about the circumference of the segmented ring.

4. The seal of claim 1, wherein said support further includes an arm and wherein the channel is defined by the arm.

5. The seal of claim 1, wherein the channel includes an inner land affixed to an inner radial face and an outer land affixed to an outer radial face.

6. The seal of claim 5, wherein the inner and outer lands are comprised of a honeycomb structure.

7. The seal of claim 5, wherein each ring segment includes a runner extending radially outward, corresponding with the outer land and a runner extending radially inward, corresponding with the inner land to define the seal.

8. The seal of claim 7, further comprising at least one contact surface on each of the attachments and the lugs, the contact surface being located at the interface of the attachments and the lugs during engine operation.

9. The seal of claim 8, wherein a ring segment includes a contact surface.

10. The seal of claim 9, wherein each ring segment includes two contact surfaces.

11. The seal of claim 10, wherein each ring segment includes two of the radially innermost contact surfaces.
